(19) United States
(12) Patent Application Publication
(10) Pub. No.: US 2026/0087587 A1
(43) Pub. Date: Mar. 26, 2026

(54) IMAGE SENSOR AND IMAGING APPARATUS INCLUDING THE SAME

(71) Applicant: Samsung Electronics Co., Ltd., Suwon-si (KR)

(72) Inventors: Seokhyeon LEE, Suwon-si (KR); Yoojeong SEO, Suwon-si (KR); Kundong KIM, Suwon-si (KR); Sungsu KIM, Suwon-si (KR)

(73) Assignee: Samsung Electronics Co., Ltd., Suwon-si (KR)

(21) Appl. No.: 19/234,401

(22) Filed: Jun. 11, 2025

(30) Foreign Application Priority Data
Sep. 26, 2024 (KR) 10-2024-0130844
Nov. 12, 2024 (KR) 10-2024-0160580

(51) Int. Cl. G06T 3/4038; H04N 9/64; H04N 23/63; H04N 23/69; H04N 25/13

(52) U.S. Cl. CPC G06T 3/4038; H04N 9/64; H04N 23/632; H04N 23/69; H04N 25/13

(57) ABSTRACT

In some embodiments, an imaging apparatus may include an image sensor, a display device or a storage device, and an application processor. The image sensor May include a pixel array including a plurality of pixels, the pixel array providing a pixel signal, a non-Bayer patterned color filter array disposed on the pixel array, a readout circuit configured to output non-Bayer patterned first image data based on the pixel signal, and an image signal processor configured to remosaic at least a portion of the first image data and output Bayer patterned second image data. The application processor may be configured to control the image sensor, generate Bayer patterned third image data based on the Bayer patterned second image data, and, based on the third image data, display a preview image on the display device or store a capture image in the storage device.

### CROSS-REFERENCE TO RELATED APPLICATION(S)

This U.S. non-provisional application claims priority under 35 U.S.C. § 119 to Korean Patent Application No. 10-2024-0130844, filed on Sep. 26, 2024, and Korean Patent Application No. 10-2024-0160580, filed on Nov. 12, 2024, in the Korean Intellectual Property Office, the disclosures of which are herein incorporated by reference in their entireties.

### TECHNICAL FIELD

Disclosed embodiments relate to an image sensor and an imaging apparatus including the same, and more particularly, to an image sensor and an imaging apparatus for generating capture images without experiencing shutter lag.

### BACKGROUND

An image sensor is a device for converting light signals into electrical signals.

A pixel having a complementary metal-oxide semiconductor (CMOS) image sensor (CIS) may be used to obtain data related to captured images based on electrical signals generated by CMOS transistors (also located on the pixel).

In-sensor zoom functions have been used in image sensors and imaging apparatuses. When performing an in-sensor zoom function, an image sensor may crop a zooming-requested portion of sensed image data and output cropped image data. However, when high-resolution in-sensor zoom imaging is performed using current technology, shutter lag occurs during the capturing of cropped image data, resulting in reduced quality, resolution, and timing accuracy for the captured image. This occurs at least in part because pre-stored images cannot be used to generate a capture image as a result of required changes between image sensor modes.

### SUMMARY

Example embodiments include an image sensor and an imaging apparatus for generating capture images without experiencing shutter lag.

According to an example embodiment, an imaging apparatus includes an image sensor, a display device or a storage device, and an application processor. The image sensor may include a pixel array including a plurality of pixels, the pixel array providing a pixel signal, a non-Bayer patterned color filter array disposed on the pixel array, a readout circuit configured to output non-Bayer patterned first image data based on the pixel signal, and an image signal processor configured to remosaic at least a portion of the first image data and output Bayer patterned second image data. The application processor may be configured to control the image sensor, generate Bayer patterned third image data based on the Bayer patterned second image data, and based on the generated Bayer patterned third image data, display a preview image on the display device, or store a capture image in the storage device.

According to another example embodiment, an image sensor includes a pixel array comprising a plurality of pixels, the pixel array providing a pixel signal, a non-Bayer patterned color filter array disposed on the pixel array, a readout circuit configured to output non-Bayer patterned first image data based on the pixel signal, and an image signal processor configured to receive a zoom command from an application processor, receive a preview command from the application processor, and remosaic at least a portion of the non-Bayer patterned first image data and output Bayer patterned second image data in response to both the zoom command and the preview command.

According to yet another example embodiment, an electronic device includes an image sensor, a display device or a storage device, and an application processor. The application processor may be configured to control the image sensor, receive Bayer patterned first image data from the image sensor, remove one or more artifacts from the Bayer patterned first image data to generate Bayer patterned second image data, and display a preview image based on the Bayer patterned second image data on the display device, or store a capture image based on the Bayer patterned second image data in the storage device.

### BRIEF DESCRIPTION OF DRAWINGS

FIG. 1 is a diagram illustrating an imaging apparatus according to an example embodiment.

FIG. 2 is a diagram illustrating an image sensor according to an example embodiment.

FIG. 3 is a diagram illustrating a tetra pattern color filter unit, one or more of which may comprise a non-Bayer patterned color filter array, consistent with disclosed embodiments.

FIGS. 4A and 4B are diagrams illustrating an in-sensor zoom operation according to related arts and an in-sensor zoom operation consistent with disclosed embodiments, respectively.

FIG. 5 is a block diagram illustrating an exemplary configuration of an image signal processor, consistent with disclosed embodiments.

FIG. 6 is a diagram illustrating an exemplary arrangement for a color interpolation operation performed during a remosaic operation of a remosaic circuit of FIG. 5, consistent with disclosed embodiments.

FIG. 7 is a diagram illustrating the operation of the remosaic circuit of FIG. 5, according to an example embodiment.

FIG. 8 is a diagram illustrating an application processor according to an example embodiment.

FIG. 9 is a diagram illustrating a frame buffer of a memory device, consistent with disclosed embodiments.

FIG. 10 is a diagram illustrating a preview image generation operation of an imaging apparatus according to an example embodiment.

FIG. 11 is a diagram illustrating a capture image generation operation of the imaging apparatus according to an example embodiment.

FIG. 12 is a diagram illustrating a capture image generation operation according to related arts.

FIG. 13 is a diagram illustrating a capture image generation operation of the imaging apparatus of FIG. 1, according to an example embodiment.

FIG. 14 is a diagram illustrating a video frame generation operation of the imaging apparatus of FIG. 1, according to an example embodiment.

FIG. 15 is a block diagram of an imaging apparatus according to an example embodiment.

FIG. 16 is a flowchart illustrating the operation of an imaging apparatus according to an example embodiment.

### DETAILED DESCRIPTION

Hereinafter, example embodiments will be described with reference to the accompanying drawings.

Throughout the specification, the terms “circuit,” “unit,” and “block” are used to distinguish components, and each may be implemented as hardware, software, or a combination of hardware and software. The terms “circuit,” “unit,” and “block” do not refer to any specific type, such as hardware and/or software.

Throughout the specification, the term “Bayer patterned image data” refers to image data that has a form of output based on a Bayer patterned pixel array, while “non-Bayer patterned image data” refers to image data that has a form of output based on a non-Bayer patterned pixel array. In particular, “Tetra patterned image data” refers to image data based on a Tetra patterned pixel array, and “Nona patterned image data” refers to image data based on a Nona patterned pixel array.

For example, matrix-form Bayer patterned image data corresponding to one frame may include a plurality of 2×2 matrix-form image data groups. In this case, two non-adjacent image data within each group may correspond to pixels including green color filters, and the remaining two image data may correspond to pixels including red and blue color filters, respectively.

Meanwhile, the term “non-Bayer patterned image data” may refer to image data other than the Bayer patterned image data. For example, matrix-form tetra patterned image data corresponding to one frame may include a plurality of image data groups each having a 2×2 matrix form, which follow a Bayer pattern arrangement.

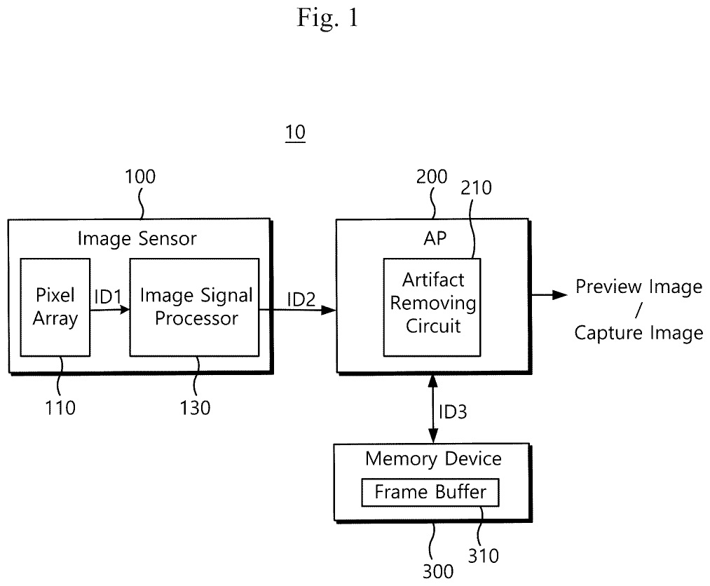

FIG. 1 is a diagram illustrating an imaging apparatus 10 according to an example embodiment.

As exemplified in FIG. 1, the imaging apparatus 10 may receive the same image data ID2 from an image sensor 100 both when generating a preview image and when generating a capture image. The imaging apparatus 10 may generate a capture image with zero shutter lag.

Referring to FIG. 1, the imaging apparatus 10 may include an image sensor 100, an application processor 200, and a memory device 300.

In some embodiments, and as shown in FIG. 1, the image sensor 100 may include a pixel array 110 and an image signal processor 130.

In some embodiments, and as shown in FIG. 1, the pixel array 110 may include a plurality of pixels. The plurality of pixels may generate a pixel signal based on an optical signal received through a lens and a color filter. The pixel array 110 may output first image data ID1 based on the pixel signal.

In some embodiments, and as shown in FIG. 1, the pixel array 110 may output non-Bayer patterned first image data ID1. In an example embodiment, a color filter array may be disposed on the pixel array 110 in a non-Bayer pattern rather than, e.g., a Bayer pattern. For example, the color filter array may be a non-Bayer patterned color filter array.

For example, in the case of a Bayer patterned color filter array, color filters of different colors may be disposed in at least some adjacent pixels, among a plurality of pixels. As another example, and in the case of a non-Bayer patterned color filter, color filters of the same color may be disposed in at least some adjacent pixels, among a plurality of pixels.

In some embodiments, and as further shown in FIG. 1, the image signal processor 130 may output the second image data ID2, obtained by image-processing the non-Bayer patterned first image data ID1 received from the pixel array 110. The second image data ID2 may be transmitted to the application processor 200.

In an example embodiment, the image signal processor 130 may generate the second image data ID2 by remosaicking (e.g., reconstructing a full-resolution color image from) the non-Bayer patterned first image data ID1.

In some embodiments, the application processor 200 may control the image sensor 100 and the memory device 300. For example, the application processor 200 may support various applications such as user applications, personal computer (PC) applications, or mobile applications. In some embodiments, the application processor 200 may control the image sensor 100 and the memory device 300 according to a user request and/or an application request.

In some embodiments, the application processor 200 may temporarily store the second image data ID2 in the memory device 300. In some embodiments, the application processor 200 may generate third image data ID3 obtained by image-processing the second image data ID2. In some embodiments, the application processor 200 may generate a preview image or a capture image using the third image data ID3.

In an example embodiment, the application processor 200 may remove artifacts from the Bayer patterned second image data ID2 and generate Bayer patterned third image data ID3. In some embodiments, the application processor 200 may demosaic (e.g., reverse or undo a remosaicking of) the Bayer patterned second image data ID2 or the Bayer patterned third image data ID3 and generate a preview image or a capture image.

In some embodiments, the preview image may be generated in response to a camera-on request from the user and/or application. In some embodiments, the application processor 200 may display the preview image on a display device.

In some embodiments, the capture image may be generated in response to a capture request from the user and/or application. In some embodiments, the capture request may be a request to store an image in a storage device.

According to an example embodiment, even when the generation of a capture image is required during the generation of a preview image, the application processor 200 may be configured not to request a change in image sensor operation (e.g., an operation or mode of the image sensor 100).

Consistent with the example embodiment described above, the operation of the image sensor 100 may be the same for generating both a preview image and a capture image. In other words, the image sensor 100 need not change its operation(s) associated with generating the capture image while performing operation(s) such as, e.g., transmitting image data, for generating the preview image (and vice versa).

For example, the image signal processor 130 may remosaic the non-Bayer patterned first image data ID1 and output the Bayer patterned second image data ID2 both when generating a preview image and when generating a capture image.

In an example embodiment, the image sensor 100 may not change its operation(s) associated with generating a preview image and/or its operation(s) associated with generating a capture image, and the application processor 200 may receive the Bayer patterned second image data ID2 from the image sensor 100 both when generating a preview image and when generating a capture image.

In some embodiments, the application processor 200 may, in response to a capture request, generate a capture image using the third image data ID3 stored in the memory device 300 used for the preview image. A plurality of pieces of the third image data ID3 used to generate the capture image may be the same as a plurality of pieces of image data stored in the memory device 300 (e.g., before the capture request is received). As a result, the imaging apparatus 10 may generate a capture image using preview image data; hence, the capture image may have minimal or zero shutter lag because the operation (or mode) of the image sensor need not alter (e.g., based on whether a preview image or a capture image is desired).

In an example embodiment, the application processor 200 may generate a preview image and/or a capture image in an in-sensor zoom mode.

The in-sensor zoom mode may be a mode in which zoomed image data is output based on a pixel signal generated from the pixel array 110 without a physical movement of a lens.

For example, in an optical zoom mode, a focal length of the lens and a field of view (FOV) of a camera may be changed through physical movement of the lens, and image data based on the changed FOV may be output from the image sensor 100. In the in-sensor zoom mode, the image sensor 100 may crop a portion of the first image data ID1 to generate second image data without adjusting the FOV of the camera.

As an example, in related arts, an image signal processor may perform different image processing operations when generating a preview image versus when generating a capture image. Accordingly, a mode change of the image sensor may occur based on whether the imaging apparatus is generating a preview image or a capture image. Similarly, in related arts, a sensor mode change may occur to generate a capture image (when a capture request is received) while performing an in-sensor zoom function (e.g., while viewing a preview image).

Therefore, in related arts, time may be required for the occurrence of a mode change of the image sensor. Accordingly, shutter lag may occur when generating a capture image. In addition, when the image sensor changes from a mode for generating a preview image to a mode for generating a capture image, an application processor may be unable to use pre-stored image data, e.g., to generate the capture image in the same mode used for generating the preview image. Furthermore, in related arts, it may be difficult to generate a high-quality capture image when using the same mode as that used for generating the preview image.

In some embodiments, and with further reference to FIG. 1, the image sensor 100 may output Bayer patterned second image data ID2 in the in-sensor zoom mode, both when generating a preview image and when generating a capture image. In the in-sensor zoom mode, the application processor 200 may generate a capture image using the image data used for the preview image and stored in the frame buffer 310. As a result, the imaging apparatus 10 may generate a capture image without shutter lag (e.g., with zero shutter lag) in the in-sensor zoom mode.

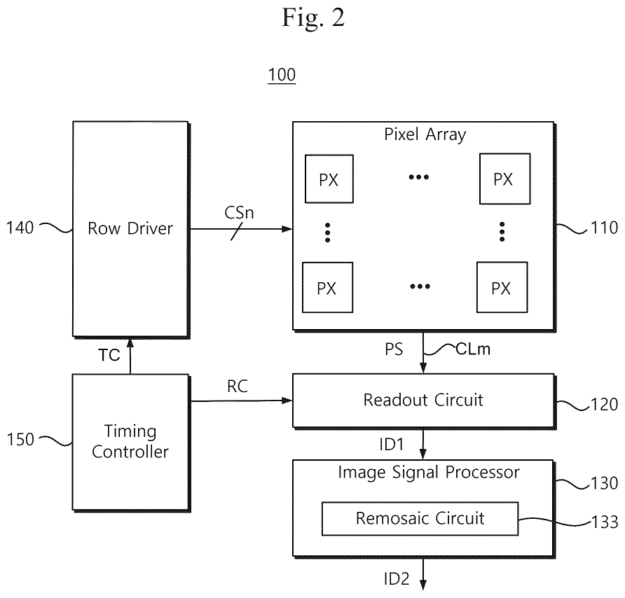

FIG. 2 is a diagram illustrating an image sensor 100 according to an example embodiment.

In some embodiments, and referring to FIG. 2, the image sensor 100 may include a pixel array 110, a readout circuit 120, an image signal processor 130, a row driver 140, and a timing controller 150.

In some embodiments, the pixel array 110 may include a plurality of pixels PX. The plurality of pixels PX may be arranged, for example, in a matrix. The pixel array 110 may receive a plurality of pixel driving signals CSn, such as a select signal, a reset signal, and a transfer control signal, from the row driver 140. The pixel array 110 may operate under the control of the received pixel driving signals CSn.

In some embodiments, each of the plurality of pixels PX may convert an optical signal into an electrical signal using at least one photoelectric conversion element.

In some embodiments, the pixel array 110 may provide pixel signals PS, output from the plurality of pixels PX, to the readout circuit 120 through a plurality of column lines CLm.

In some embodiments, the photoelectric conversion element may be a photodiode PD. The photodiode PD may refer to, e.g., a type of photoelectric conversion element that generates charges in proportion to an optical signal incident on each pixel and accumulates the generated charges. The photoelectric conversion element may be, e.g., a photodiode PD, a photocapacitor, a photogate, a pinned photodiode PPD, a partially pinned photodiode, an organic photodiode OPD, a quantum dot QD, or combinations thereof.

Although example embodiments are described with a photodiode PD as the photoelectric conversion element, other photoelectric conversion elements, not limited to those described above, may also be used. Therefore, the photoelectric conversion element is not limited to a photodiode PD.

In some embodiments, a pixel array may include a color filter array. The color filter array may include a plurality of color filters. In an example embodiment, the color filter array may be a non-Bayer pattern color filter array. In some embodiments, each of the plurality of color filters may be disposed in the color filter array with a non-Bayer pattern.

For example, the same color filters may be disposed in some adjacent pixels among the plurality of pixels. In some embodiments, a color filter group may comprise color filters of the same color. In some embodiments, a color filter unit may comprise a plurality of color filter groups. In some embodiments, color filters included in each of the plurality of color filter groups may be arranged in an M×N matrix, where M and N are positive integers.

In some embodiments, the readout circuit 120 may include an analog-to-digital converter. The analog-to-digital converter of the readout circuit 120 may convert the pixel signal PS into a digital signal and output the digital signal. For example, the analog-to-digital converter may sample a pixel signal using correlated double sampling and convert the sampled pixel signal into first image data ID1, e.g., a digital signal. To this end, in some embodiments, a correlated double sampler CDS may be further disposed in front of the analog-to-digital converter.

In some embodiments, the readout circuit 120 may convert the pixel signal PS of the pixel array 110 into a digital signal and output the first image data ID1.

In some embodiments, the row driver 140 may select a single row of the pixel array 110 under the control of the timing controller 150. The row driver 140 may generate a select signal CSn to select a single row among a plurality of rows of the pixel array 110. In some embodiments, the row driver 140 may activate pixels PX corresponding to the selected row. A pixel signal PS of the pixels PX of the selected row may be transmitted to the analog-to-digital converter of the readout circuit 120.

In some embodiments, the timing controller 150 may control the pixel array 110, the row driver 140, the readout circuit 120, and/or the image signal processor 130. In some embodiments, the timing controller 150 may provide a timing control signal TC to the row driver 140. In some embodiments, the timing controller 150 may provide a reference code RC to the readout circuit 120.

According to an example embodiment, the readout circuit 120 may output non-Bayer patterned first image data ID1.

In some embodiments, the image signal processor 130 may include a remosaic circuit 133. The remosaic circuit 133 may remosaic the non-Bayer patterned image data and output Bayer patterned second image data ID2. In some embodiments, the image signal processor 130 may remosaic the non-Bayer patterned image data and output the Bayer patterned second image data ID2 both when generating a preview image and when generating a capture image.

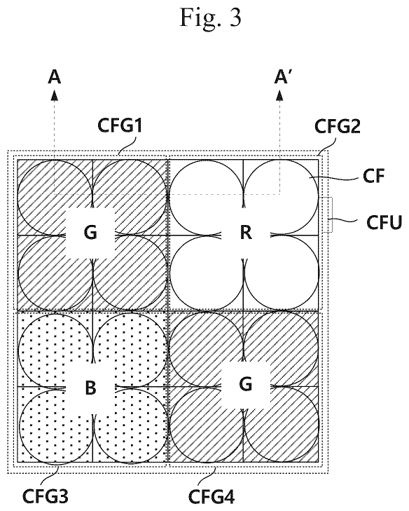

FIG. 3 is a diagram illustrating an exemplary tetra pattern color filter unit, one or more of which may comprise a non-Bayer patterned color filter array, consistent with disclosed embodiments.

In some embodiments, the color filter array may include a plurality of color filter groups and/or color filters.

In an example embodiment, and with reference to FIG. 3, color filter groups CFG1, CFG2, CFG3, and CFG4 may each include one color filter CF having a single color. A color filter unit CFU may include a plurality of color filter groups CFG1, CFG2, CFG3, and CFG4. The color filter array described with reference to FIG. 1 may, e.g., include at least one color filter unit CFU.

In an example embodiment, a pixel array may include a plurality of the tetra pattern color filter units CFU of FIG. 3 repeatedly disposed in a pixel array (e.g., the pixel array 110 of FIGS. 1 and 2).

In some embodiments, and referring further to FIG. 3, each of the tetra pattern color filter units CFU may include tetra pattern color filter groups CFG1, CFG2, CFG3, and CFG4, and each tetra pattern color filter groups CFG1, CFG2, CFG3, and CFG4 may include one color filterCF having the same color. In some embodiments, the color filter unit CFU may include two green color filter groups G, a single red color filter group R, and a single blue color filter group B, as shown in the example of FIG. 3. In some embodiments, color filter groups having different colors may be disposed adjacent to each other. In some embodiments, color filter groups having the same colors may be disposed adjacent to each other.

A non-Bayer patterned color filter array according to some embodiments may be based on Nona (e.g., Nonacell) patterned color filters or tetra square (e.g., Hexadeca Bayer) patterned color filters, in addition to or in place of the tetra pattern color filters described with reference to FIG. 3. However, these are only examples, and disclosed embodiments are not limited thereto.

According to an example embodiment, a pixel array (e.g., the pixel array 110 of FIGS. 1 and 2) may output first image data ID1 based on one of the tetra pattern, Nona pattern, and tetra square pattern. In some embodiments, an image signal processor (e.g., the image signal processor 130 of FIGS. 1 and 2) may remosaic the first image data ID1 based on one of the tetra pattern, Nona pattern, and tetra square pattern.

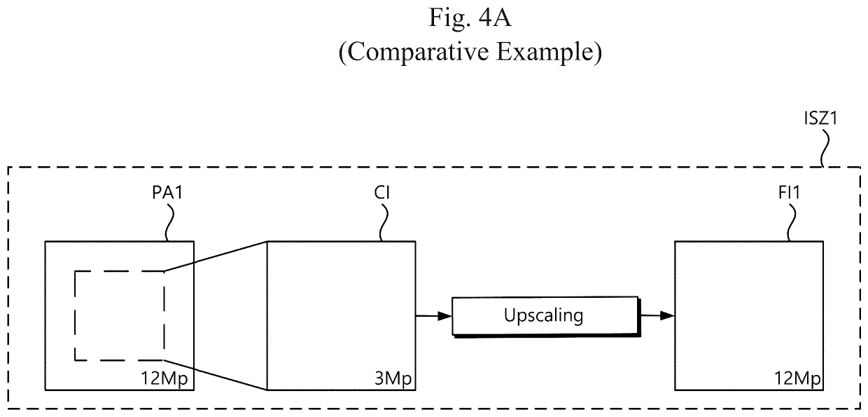

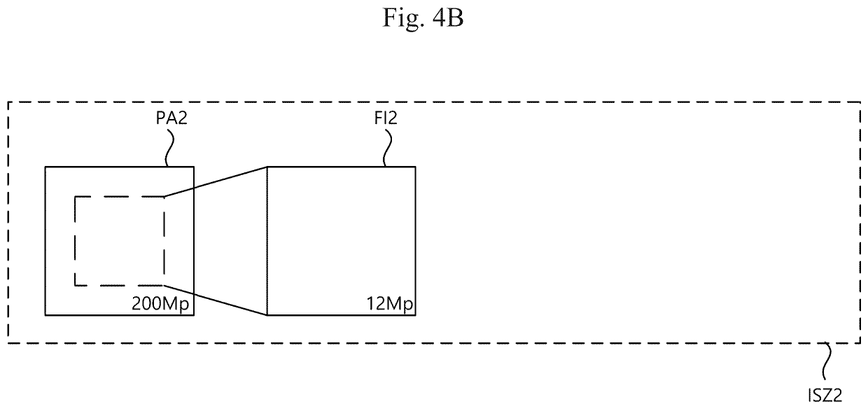

FIG. 4A is a diagram illustrating an in-sensor zoom operation ISZ1 according to related arts and FIG. 4B is a diagram illustrating an exemplary in-sensor zoom operation ISZ2 consistent with disclosed embodiments. The in-sensor zoom operation ISZ2 described with reference to FIG. 4B may be performed in an imaging apparatus (e.g., the imaging apparatus 10 of FIG. 1).

An image sensor shown in FIG. 4A may include a low-resolution pixel array PA1. In an in-sensor zoom operation ISZ1 of the image sensor of FIG. 4A, the resolution of a cropped image is significantly low during a zoom-in operation. Therefore, the cropped image CI in the in-sensor zoom operation ISZ1 performed according to FIG. 4A is limited in its capability to improve image quality, even, e.g., after post-processing. An application processor according to the related art may upscale (e.g., perform upscaling on) the cropped image CI and generate an upscaled cropped image FI1 in an attempt to restore image quality. However, the restored image quality in the upscaled cropped image FI1 is still limited.

In contrast to the related art and with reference to FIG. 4B, a pixel array consistent with disclosed embodiments (e.g., the pixel array 110 of FIGS. 1 and 2) may include equal or more than 100 million pixels. Therefore, in FIG. 4B, the cropped image FI2, captured during the in-sensor zoom operation ISZ2 of the pixel array PA2, has a higher resolution than a cropped image CI generated in the in-sensor zoom operation ISZ1 of FIG. 4A. As a result, the cropped image FI2 in the in-sensor zoom operation ISZ2 of the pixel array PA2 may be used as a preview image and/or a capture image after simple image processing, and further without needing upscaling to improve or restore a cropped or captured image, as the cropped image FI2 may have a higher resolution than upscaled cropped image FI1 of FIG. 4A.

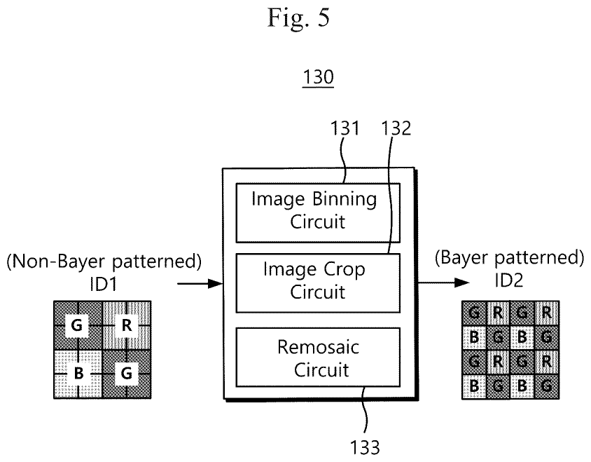

FIG. 5 is a block diagram illustrating an exemplary configuration of the image signal processor 130, consistent with disclosed embodiments. The image signal processor 130 of FIG. 5 may correspond to the image signal processor 130 of FIGS. 1 and 2. The image signal processor 130 will be described with reference to FIGS. 1, 2, and 7. Detailed descriptions redundant or similar to those provided for FIGS. 1 and 2 above are omitted hereinafter.

The image signal processor 130 according to an example embodiment as that shown in FIG. 5 may include an image binning circuit 131, an image crop circuit 132, and a remosaic circuit 133. However, this is only an example, and the image signal processor 130 is not limited thereto, and may further include circuits for processing noise reduction, white balance, color correction, sharpening, or other features. In some embodiments, the image signal processor 130 may not include the image binning circuit 131.

In an example embodiment, the image signal processor 130 may process image data in a different way depending on a command received from the application processor. For example, the image sensor 100 of FIGS. 1 and 2 may receive a preview command and/or a zoom command from the application processor 200.

The application processor 200 may transmit a preview command to the image sensor 100, for example, in response to a user's camera-on request.

In an example embodiment, when a zoom operation is not being performed, the image binning circuit 131 of the image signal processor 130 may bin first image data in response to the preview command. For example, the image binning circuit 131 may bin image data generated from a plurality of adjacent pixels (e.g., pixels PXa, having the structure of FIG. 4A). The image binning circuit 131 may bin the first image data ID1 to, e.g., reduce noise or improve sensitivity in a low-illuminance (e.g., darkened or low light) environment.

In an example embodiment, when a zoom operation is not being performed, image data generated from the pixel PXb having the structure of FIG. 4B may be binned by image binning circuit 131 in response to the preview command. In some embodiments, the image binning circuit 131 may not bin the image data.

In some embodiments, the application processor 200 may transmit a zoom command to the image sensor 100 in response to a user's zoom-in request. The zoom command may be transmitted, for example, during a preview operation.

In an example embodiment, and with reference to FIG. 5, the image crop circuit 132 may crop a portion of the first image data ID1 in response to the zoom command. For example, the image crop circuit 132 may crop only the first image data ID1 which corresponds to a region of the first image data ID1 after being zoomed in by a user (e.g., upon receiving the zoom command).

With further reference to the example embodiment of FIG. 5, the remosaic circuit 133 may remosaic the first image data ID1 output from the image binning circuit 131 or from the image crop circuit 132 and output the second image data ID2.

For example, the remosaic circuit 133 may remosaic non-Bayer patterned first image data ID1 based on a non-Bayer patterned color filter array, convert a remosaicked version of the first image data ID1 into Bayer patterned second image data ID2, and output the remosaicked version.

In an example embodiment, the remosaic circuit 133 may remosaic the first image data ID1 based on interpolation. For example, the remosaic circuit 133 may remosaic the first image data ID1 based on green interpolation and/or chrominance (UV) interpolation.

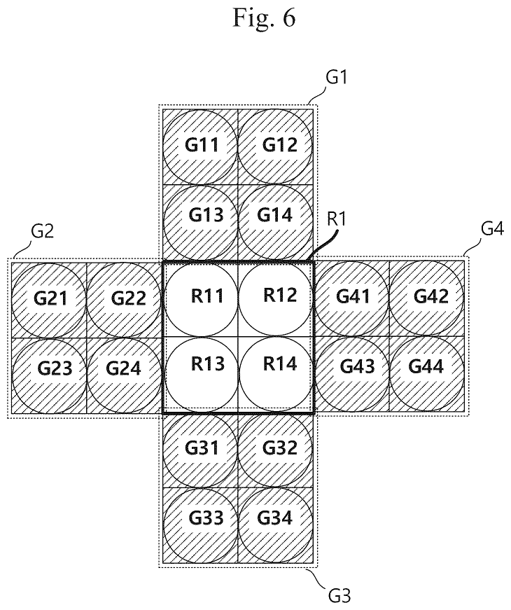

FIG. 6 is a diagram illustrating an exemplary color arrangement used during an exemplary color interpolation operation performed during the remosaic operation of the remosaic circuit 133 of FIG. 5, consistent with disclosed embodiments. FIG. 6 illustrates an exemplary color arrangement which may be used for generating image data for a green channel. Using similar patterns while changing respective colors, the remosaic circuit 133 may generate image data, e.g., for each of a green channel and a blue channel.

An operation, in which the remosaic circuit 133 generates a green channel based on interpolation, will be described with reference to FIG. 6. The operation associated with FIG. 6 may be performed by the remosaic circuit 133, for example, during a remosaic processing operation of the non-Bayer patterned first image data ID1 of FIG. 5.

The first image data ID1 may be based on a color arrangement of the color filter array. In an exemplary embodiment, the first image data ID1 may include information on only one color for each pixel. In such embodiments, the remosaic circuit 133 may interpolate information on a single color to generate information on other colors.

Hereinafter, in the embodiment described with reference to FIG. 6, a plurality of pieces of first image data corresponding to a color filter group of a specific color in the color filter array will be referred to as an image data group (e.g., a red image data group, a green image data group, or a blue image data group). For example, FIG. 6 illustrates a red image data group R1 referring to red image data at the center, and green image data groups G1, G2, G3, and G4 referring to a plurality of pieces of green image data surrounding the red image data group R1. In addition, FIG. 6 illustrates that image data corresponding to each pixel of each image data group may be distinguished, e.g., using particular numbers. For example, as shown in FIG. 6, G41 may be image data corresponding to a first pixel of image data group G4. Image data corresponding to a particular pixel or group of pixels may be referred to herein as pixel data.

Referring further to FIG. 6, four 2×2 array green image data groups G1, G2, G3, and G4 may be disposed adjacent to a 2×2 array red image data group R1. Information corresponding to a green component of a plurality of pieces of pixel data of the red image data group R1 may be generated by interpolating a plurality of pieces of pixel data of the green image data groups G1, G2, G3, and G4.

For example, and with reference to FIG. 6, information corresponding to the green components of pixel data R12 of the red image data group R1 may be generated by interpolating pixel data G13, G14, G41, and G43. Weights may be applied to the pixel data, and the applied weights may be different depending, e.g., on locations of the pixel data G13, G14, G41, and G43 and the location of the pixel data R12. In addition, a plurality of pieces of pixel data other than the pixel data G13, G14, G41, and G43 may also or alternatively be used depending on an interpolation method. Furthermore, the method is not limited to a specific or single interpolation method.

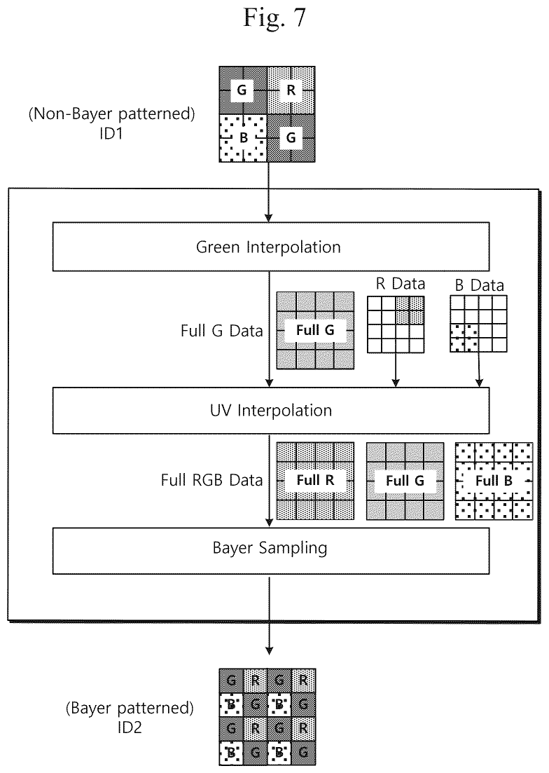

In some embodiments, when the same operation is performed on all pieces of pixel data of the red image data group R1, the generation of information corresponding to the green components of the red image data group R1 may be completed. The same operation may be performed on the remaining red image data groups, blue image data groups, or other colored data groups. As a result, information corresponding to the green components of the entire image data (e.g., the entire pixel array) may be generated. FIG. 7 is a diagram illustrating the operation of the remosaic circuit 133 of FIG. 5 according to an example embodiment.

In an example embodiment, and as shown in FIG. 7, the remosaic circuit 133 may output Bayer patterned second image data ID2. For example, the remosaic circuit 133 may generate full green data (Full G Data) through green interpolation, e.g., as described with reference to FIG. 6, using the non-Bayer patterned first image data ID1. The remosaic circuit 133 may generate chrominance information through chrominance interpolation of the full green data (Full G Data), blue data (B Data), and red data (R Data). The remosaic circuit 133 may generate full red data (Full R) and full blue data (Full B) based, e.g., on the full green data (Full G Data) and the chrominance information.

In an example embodiment, a remosaic circuit (e.g., the remosaic circuit 133 of FIG. 5) may generate luminance information and chrominance information based on information corresponding to green components within the entire image data. For example, the luminance information and the chrominance information may be generated based on a YUV color space. In some embodiments, the remosaic circuit 133 may generate luminance information Y based on the full green data (Full G Data). In some embodiments, the remosaic circuit 133 may generate chrominance information (UV Interpolation) based on the full green data (Full G Data), blue data (B Data), and red data (R Data). In some embodiments, the remosaic circuit 133 may generate full red data (Full R) and/or full blue data (Full B) based on the full green data (Full G Data) and the chrominance information (e.g., a result of the UV Interpolation).

In some embodiments, and as further shown in FIG. 7, the remosaic circuit 133 may perform Bayer sampling on final RGB data (Full R, Full G, and Full B) of the first image data ID1 and generate the Bayer patterned second image data ID2.

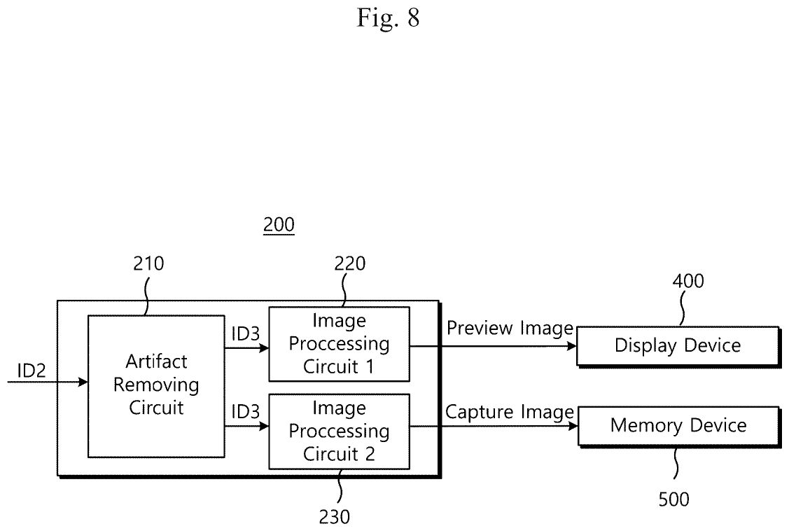

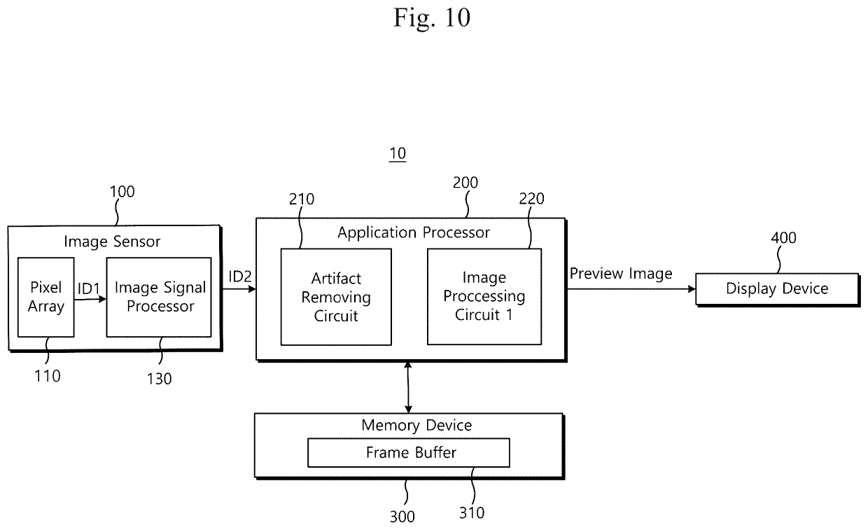

FIG. 8 is a diagram illustrating an application processor 200 according to an example embodiment. The application processor 200 of FIG. 8 may correspond, for example, to the application processor 200 of FIG. 1. The application processor 200 will be described with reference to FIGS. 1 and 10. Detailed descriptions redundant or similar to those provided for FIGS. 1 and 10 above are omitted hereinafter.

The application processor 200 according to an example embodiment, as shown in FIG. 8, may include an artifact removing circuit 210, a first image processing circuit 220, and a second image processing circuit 230.

The application processor 200 may receive the second image data ID2 from a Bayer pattern of an image sensor (e.g., the image sensor 100 of FIG. 1). The application processor 200 may process the second image data ID2, and display the processed second image data ID2 on a display device or store the processed second image data ID2 in a storage device. The application processor 200 may perform image processing to improve image quality of the second image data ID2. The application processor 200 according to an example embodiment may perform processing, such as artifact removal, noise reduction, white balance, color correction, or sharpening, on the second image data ID2.

In some embodiments, the artifact removing circuit 210 may include one or more of a neural processor, a graphics processor, a logic circuit, a field-programmable gate array (FPGA), and an artificial intelligence (AI) accelerator.

In some embodiments, the artifact removing circuit 210 may remove artifacts based on a deep learning-based neural network.

For example, the artifact removing circuit 210 may input Bayer patterned second image data ID2 to the deep learning-based neural network and output Bayer patterned third image data ID3 with artifacts removed. The deep learning-based neural network may be trained, for example, with training data comprising labeled Bayer patterned image data including artifacts and labeled Bayer patterned image data with artifacts removed.

In an example embodiment, the artifact removing circuit 210 may remove artifacts of the Bayer patterned second image data ID2 based on the deep learning-based neural network and output third image data ID3 having the same resolution as the second image data ID2. Accordingly, the artifact removing circuit 210 may remove the artifacts of the second image data ID2 at a high speed and the artifact removing circuit may operate in real time. As a result, the application processor 200 may generate capture images and video frames in real time using the Bayer patterned second image data ID2.

In some embodiments, the first image processing circuit 220 may include a gain adjustment circuit, a contrast adjustment circuit, or another circuit, to correct the third image data ID3. For example, the first image processing circuit 220 may perform image gain adjustment, contrast adjustment, or another adjustment of the third image data ID3 and output a preview image. The preview image may be displayed, e.g., on a display device (e.g., display device 400).

In some embodiments, the second image processing circuit 230 may include a filter, a gain adjustment circuit, a noise reduction circuit, a contrast adjustment circuit, or another circuit, to correct the third image data ID3. The second image processing circuit 230 may, e.g., improve the image quality based on each pixel data of the input third image data ID3. The second image processing circuit 230 may, for example, perform image gain adjustment, contrast adjustment, noise reduction, or another adjustment or reduction, of the third image data ID3 and output a capture image. The capture image may be stored, e.g., in a storage device (e.g., memory device 500).

In an example embodiment, the second image processing circuit 230 may store a capture image, obtained by converting the third image data ID3 into an image format such as joint photographic experts group (JPEG), in a storage device. However, this is only an example, and disclosed embodiments are not limited thereto. For example, the second image processing circuit 230 may convert the third image data ID3 into an image format such as graphics interchange format (GIF), bitmap (BMP), or portable network graphics (PNG).

The storage device (or memory device) may include a non-volatile memory such as a flash memory, a ferroelectric random access memory (FRAM), or a magnetoresistive random access memory (MRAM).

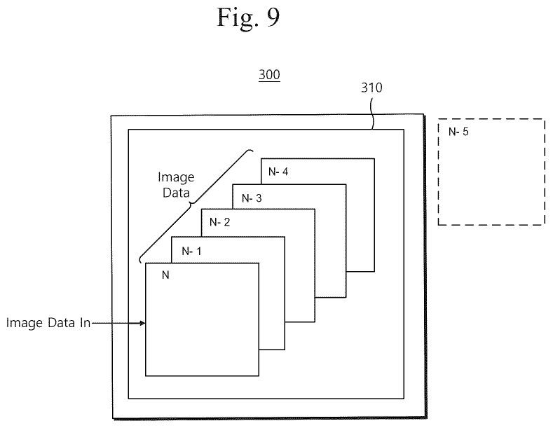

FIG. 9 is a diagram illustrating an exemplary frame buffer 310 of an exemplary memory device 300, consistent with disclosed embodiments. The frame buffer 310 may correspond, e.g., to the frame buffer 310 of FIG. 1.

The memory device 300 may include, for example, a volatile memory device such as a dynamic random access memory (DRAM), a static random access memory (SRAM), or a video random access memory (VRAM).

Referring to FIG. 9, the frame buffer 310 may store and output at least one piece of image data. FIG. 9 shows an exemplary frame buffer 310 storing image data corresponding to five frames. It will be understood that example embodiments are not limited thereto.

The frame buffer 310 may store at least one frame of image data (e.g., the second image data ID2 transmitted from the image sensor 100 of FIG. 1, or the third image data ID3 output from the artifact removing circuit 210 of FIG. 8).

In an example embodiment, the frame buffer 310 may store at least one frame of the second image data ID2 received from the image sensor 100 within a predetermined period of time from the current time. In some embodiments, the frame buffer 310 may store at least one frame of third image data ID3 output by the artifact removing circuit 210 within a predetermined period of time from the current time.

FIG. 9 shows image data at the current time as image data N, and image data N−1, image data N−2, image data N−3, and image data N−4 are shown in a sequential order of image data input in reference to the current time, wherein with reference to image data N, N−4 is the oldest stored image data and N−1 is the newest stored image data. FIG. 9 illustrates an example in which the image data N at the current time is input (Image Data In) and image data N−5 is deleted from the frame buffer 310.

The frame buffer 310 may operate, for example, in a first-in-first-out (FIFO) manner. The frame buffer 310 may store a predetermined number of pieces of image data, and image data that was first input to the frame buffer 310 may be deleted when new image data is input.

FIG. 10 is a diagram illustrating a preview image generation operation of an imaging apparatus 10 according to an example embodiment. The imaging apparatus 10 of FIG. 10 may correspond, for example, to the imaging apparatus 10 of FIG. 1.

Referring to FIG. 10, a pixel array 110 of an image sensor 100 may generate non-Bayer patterned first image data ID1.

For example, when a user turns on a camera, the image sensor 100 may receive a preview command from an application processor 200. The image signal processor 130 may remosaic the non-Bayer patterned first image data ID1 to generate Bayer patterned second image data ID2 in response to the preview command. In some embodiments, the image signal processor 130 may bin the non-Bayer patterned first image data ID1 and remosaic the binned first image data ID1.

Further referring to FIG. 10, the exemplary imaging apparatus 10 may receive a zoom-in request from a user during a preview operation. The image sensor 100 may receive a zoom-in command from the application processor 200 in response to the zoom-in request. The image signal processor 130 may crop and remosaic the non-Bayer patterned first image data ID1 to generate the Bayer patterned second image data ID2 in response to the zoom-in command.

In some embodiments, when receiving the zoom-in command during a preview operation of an image sensor, the application processor 200 may receive the Bayer patterned second image data ID2 from the image sensor 100. An artifact removing circuit 210 of the application processor 200 may remove artifacts from the second image data ID2 and generate third image data ID3.

In some embodiments, a first image processing circuit 220 of the application processor 200 may receive the third image data ID3. The first image processing circuit 220 may process the input third image data ID3 to generate a preview image and display the preview image on a display device (e.g., display device 400 of FIG. 10).

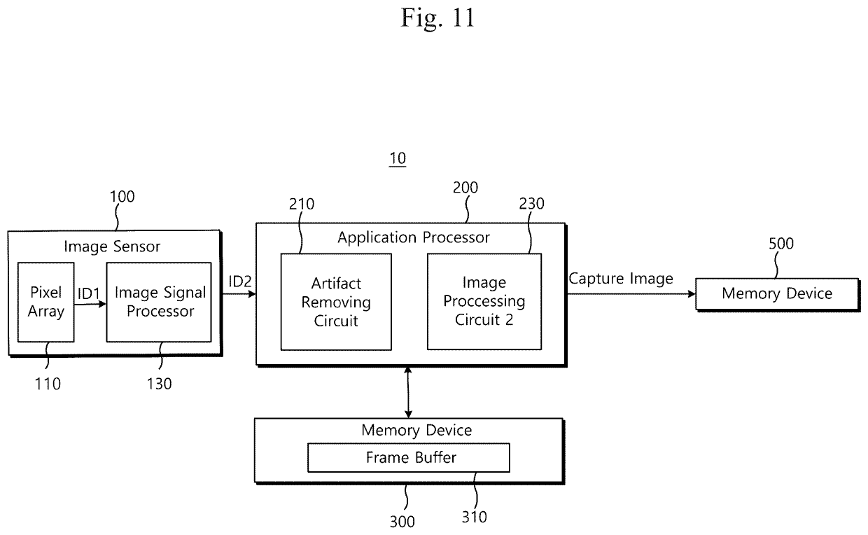

FIG. 11 is a diagram illustrating a capture image generation operation of the imaging apparatus 10 according to an example embodiment. The imaging apparatus 10 of FIG. 11 may correspond, for example, to the imaging apparatus 10 of FIG. 1. Detailed descriptions redundant or similar to those provided above with reference to FIG. 10 are omitted hereinafter.

Referring to FIG. 11, a pixel array 110 of an image sensor 100 may generate non-Bayer patterned first image data ID1.

For example, when a user turns on a camera, the image sensor 100 may receive a preview command from an application processor 200. The image sensor 100 may receive a zoom-in command from the application processor 200 during a preview operation. A pixel array 110 of the image sensor 100 may output non-Bayer patterned first image data ID1, and the image signal processor 130 may transmit the second image data ID2, obtained by remosaicking the non-Bayer patterned first image data ID1, to the application processor 200. An artifact removing circuit 210 of the application processor 200 may store third image data ID3, generated by removing the artifacts from the second image data ID2, in the memory device 500. For example, the artifact removing circuit 210 may store the third image data ID3 in the frame buffer 310 of FIG. 1.

In some embodiments, a second image processing circuit 230 of the application processor 200 may process at least one piece of third image data ID3 stored in the memory device 300 to generate a capture image in response to a user's capture request.

For example, the second image processing circuit 230 may process at least one piece of third image data ID3, stored a predetermined amount of time before a time at which a capture request is received, to generate a capture image, and may store the generated capture image in a storage device (e.g., memory device 500 of FIG. 11).

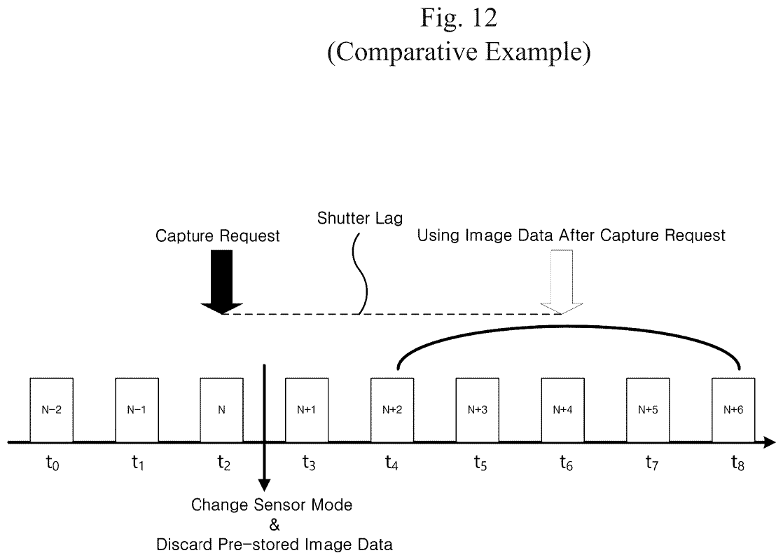

FIG. 12 illustrates the capture image generation operation according to related art. According to the related art, and as shown in FIG. 12, a capture image cannot be generated using image data pre-stored in a memory device. Accordingly, the capture image of the related art may be generated based on image data obtained a predetermined amount of time after a time at which a capture request is received from a user. As a result, shutter lag may occur.

In the case of the related art, when a capture request is made during a zoomed-in state, the sensor mode of the image sensor may change. When the sensor mode of the image sensor changes, a format of the image data output by the image sensor may also change. Accordingly, when the capture request is made during the zoomed-in state, the stored image data is not available for use before the capture request is received.

For example, in the related art, an image sensor outputs remosaicked Bayer patterned image data to generate a preview image at high speed. In the related art, when a capture request is received during an in-sensor zoom-in operation, the image sensor does not perform remosaicking to improve image quality. For example, the image sensor according to the related art outputs non-Bayer patterned image data, and an application processor performs remosaicking processing on the non-Bayer patterned image data. Therefore, the format of the image data output by the image sensor is changed, and the image data that was previously stored before the capture request is not available when generating a capture image. Accordingly, the application processor generates a capture image using image data after the capture request. As a result, shutter lag occurs based on a difference between a time at which the user presses the shutter (e.g., a capture request time) and a time at which the image data used to generate the capture image is obtained.

As a further example, FIG. 12 illustrates an exemplary case in which a capture request is received from a user at time t2. In the example of FIG. 12, a time difference between tₙ and tₙ+1 is 100 ms. In the related art, after the capture request, the above-described change in the sensor mode of the image sensor occurs, and image data (e.g., image data N−2 and image data N−1 of FIG. 9) pre-stored in the frame buffer becomes unavailable. In addition, a capture image is generated using image data after time t2. For example, when the application processor uses the image data N+4 at time t6, a shutter lag of 400 ms may occur.

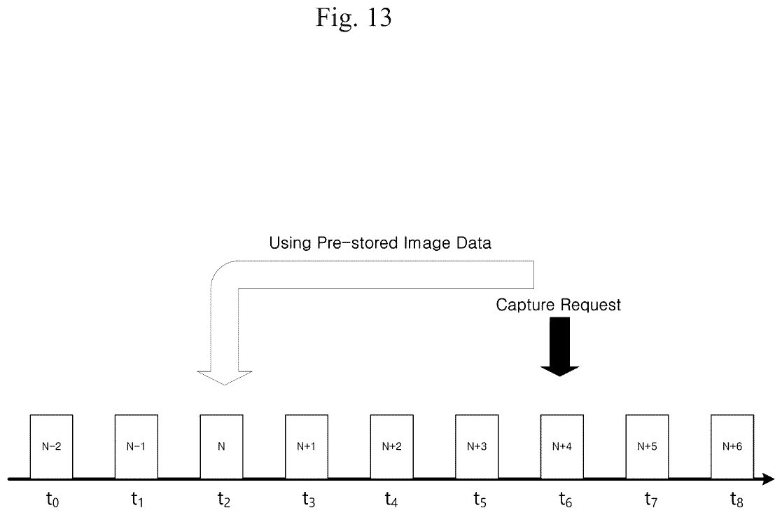

FIG. 13 is a diagram illustrating a capture image generation operation of an imaging apparatus (e.g., the imaging apparatus 10 of FIG. 1), consistent with disclosed embodiment.

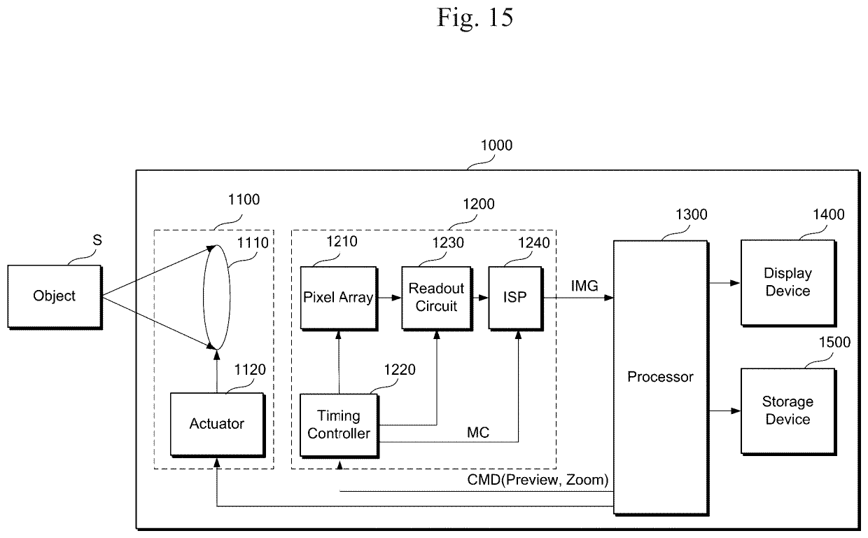

As shown in FIG. 13, the imaging apparatus 10 according to an example embodiment may generate a capture image using image data pre-stored in a memory device. Accordingly, the capture image generated by the imaging apparatus 10 may be generated based on image data a predetermined amount of time before a capture request is received from a user. As a result, shutter lag does not occur. The capture image generation operation of the imaging apparatus 10 will be described with reference to FIGS. 1 and 15.

According to some embodiments, the imaging apparatus 10 of FIG. 1 does not change the sensor mode of the image sensor even when a capture request is made in a zoomed-in state.

For example, the application processor 200 of the imaging apparatus 10 may always receive remosaicked Bayer patterned image data from the image sensor 100 to generate preview images and capture images.

Accordingly, the application processor 200 may use image data pre-stored before a capture request for generating a capture image. As a result, a capture image may be generated using at least one piece of image data near a time point at which the user presses a button or otherwise makes the capture request (e.g., a shutter capture request time). Unlike the related arts, the second image processing circuit according to an example embodiment may use at least one piece of third image data stored in the memory device before a predetermined time at which the capture request is made, among a plurality of pieces of third image data stored in the memory device, when the capture request is made. For example, the image sensor 100 of FIG. 1 may always output remosaicked image data, and the sensor mode is not changed. As a result, the imaging apparatus 10 may generate a capture image (as well as a preview image) without shutter lag.

As an example, FIG. 12 illustrates a case in which a capture request is received from a user at time t6. In the example of FIG. 12, a time difference between tₙ and tₙ+1 is 100 ms. The application processor 200 of FIG. 1 may generate a capture image using image data N stored at time t2, which is a time that is 400 ms before t6, the time at which the capture request is received. As a result, shutter lag may not occur. However, this is only an example, and example embodiments are not limited thereto. In addition, the second image processing circuit may use image data stored in the memory device before a time greater or less than 400 ms. Alternatively, the imaging apparatus 10 may generate a capture image using the image data N stored at time t2, which is 400 ms prior to time t6, and/or nearby pieces of image data (e.g., N−1 and N+1).

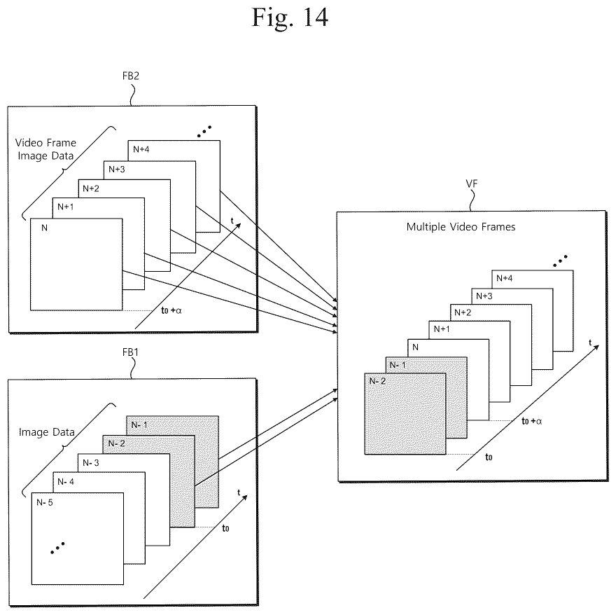

FIG. 14 is a diagram illustrating a video frame generation operation of an imaging apparatus (e.g., the imaging apparatus 10 of FIG. 1), according to an example embodiment. Detailed descriptions redundant or similar to those in the above-described embodiments are omitted hereinafter.

In some embodiments, the imaging apparatus 10 may generate at least a portion of a video frame using image data pre-stored in a memory device. Accordingly, the least a portion of the video frames generated by the imaging apparatus 10 may be generated based on image data a predetermined amount of time before a video capture request is received from a user. As a result, shutter lag does not occur in video frames.

In some embodiments, the application processor 200 of FIG. 1 may generate at least a portion of video frames using at least one piece of image data stored in a frame buffer a predetermined amount of time before a time at which a video capture request may be received, among a plurality of pieces of image data being stored in the frame buffer. For example, the application processor 200 may generate a first frame, among the video frames, using at least one piece of image data stored in the frame buffer a predetermined amount of time before a time at which a video capture request is received. Additionally, the application processor 200 may generate a plurality of frames, among the video frames, using image data stored in the frame buffer before the predetermined amount of time before the time at which the video capture request is received.

Referring to FIG. 14, an example is provided in which the application processor 200 receives a video capture request at time t₀+α. The imaging device 10 may generate at least a portion of the video frames using the image data stored in the frame buffer from time t₀ (which is a predetermined time a prior to the video capture request time t₀+α) to time t₀+α. As a result, shutter lag may not occur.

FIG. 15 is a block diagram of an imaging apparatus 1000 according to an example embodiment. Detailed descriptions redundant or similar to those in the above-described embodiments are omitted hereinafter.

As shown in FIG. 15, the imaging apparatus 1000 may include an imaging portion 1100, an image sensor 1200, a processor 1300, a display device 1400, and a storage device 1500.

In some embodiments, the processor 1300 may control the overall operation of the imaging apparatus 1000. In some embodiments, the processor 1300 may provide a control signal to the actuator 1120 to control a location of the lens 1110. As a result, a focal length may be controlled.

The imaging portion 1100, which is a light receiving component, may include a lens 1110 and an actuator 1120. In some embodiments, the lens 1110 may include a plurality of lenses.

In some embodiments, the actuator 1120 may move the lens 1110 in a direction, in which a distance from object S may increase or decrease, based, e.g., on a control signal of the processor 1300.

In some embodiments, the image sensor 1200 may generate image data and phase data based on incident light. In some embodiments, the image sensor 1200 may include a pixel array 1210, a timing controller 1220, a readout circuit 1230, and an image signal processor (ISP) 1240.

Pixels of the pixel array 1210 according to an example embodiment may include at least one photoelectric conversion element. In some embodiments, the pixel array 1210 may output non-Bayer patterned image data.

In some embodiments, the image signal processor 1240 may output Bayer patterned image data IMG obtained by remosaicking the non-Bayer patterned image data.

The image sensor 100 may output the Bayer patterned image data IMG regardless of which commands CMD (e.g., preview or zoom commands) are transmitted by the processor 1300.

In some embodiments, the processor 1300 may process the Bayer patterned image data IMG and generate a preview image or a capture image. In some embodiments, the processor 1300 may generate a capture image without shutter lag using image data stored in a frame buffer.

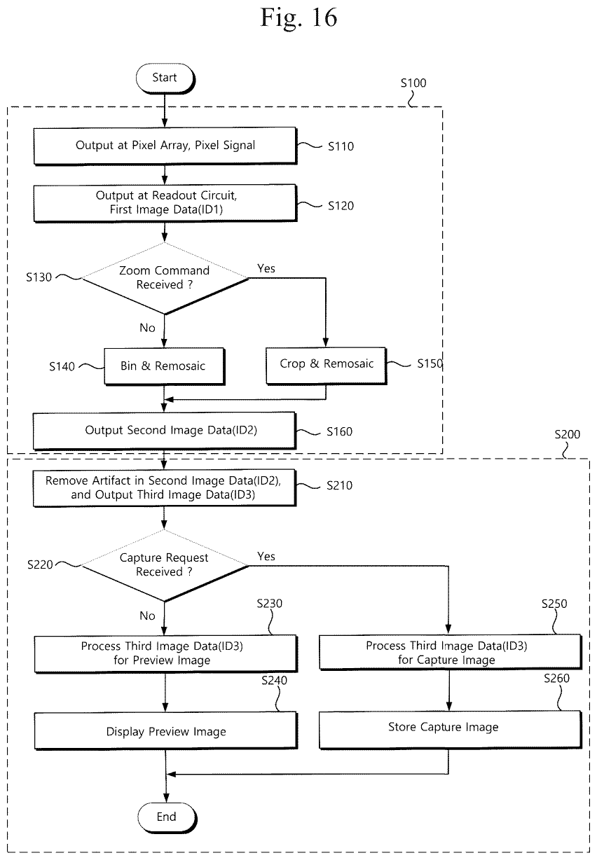

FIG. 16 is a flowchart illustrating the operation of an imaging apparatus according to an example embodiment. The operation of FIG. 16 may be performed, for example, by the imaging apparatus 10 of FIG. 1. For example, operations of S100 may be performed by the image sensor 100 of FIG. 1, and operations of S200 may be performed by the application processor 200 of FIG. 1. The operation of the imaging apparatus 10 will be described with reference to FIG. 16. Detailed descriptions redundant or similar to those provided for FIGS. 1 to 17 are omitted hereinafter.

Referring to FIG. 16, in operation S110, the pixel array 110 may generate a pixel signal.

In operation S120, the readout circuit 120 may convert the pixel signal into a digital signal and output first image data ID1. The first image data ID1 may be a non-Bayer patterned image data.

In operation S130, the image sensor 100 may determine whether a zoom command has been received from the application processor 200.

When a zoom operation is not being performed, the flow may proceed to operation S140 in which the image sensor 100 bins the first image data, remosaics the binned first image data, and generates second image data ID2. The second image data ID2 may be Bayer patterned image data.

When the zoom operation is being performed, the flow may proceed to operation S150 in which the image sensor 100 crops at least a portion of the first image data, remosaics the cropped first image data, and generates the second image data ID2. The second image data ID2 may be Bayer patterned image data.

In operation S160, the image sensor 100 may output the second image data ID2.

In operation S210, the artifact removing circuit of the application processor 200 may receive the Bayer patterned second image data ID2 transmitted by the image sensor 100 and generate Bayer patterned third image data ID3, e.g., with artifacts removed.

In operation S220, the application processor 200 may determine whether a capture request has been received from a user.

When a capture request has been received, the flow may proceed to operation S230 in which the first image processing circuit may perform first image processing on the Bayer patterned third image data ID3 to generate a preview image.

In operation S240, the application processor 200 may be configured to display the preview image on the display device.

When a capture request has been received, the flow may proceed to operation S250 in which the application processor 200 may perform second image processing on the Bayer patterned third image data ID3 to generate a capture image. In operation S260, the application processor 200 may store the capture image in a storage or memory device.

As set forth and exemplified above, an image sensor and an imaging apparatus according to an example embodiment may generate a capture image without shutter lag.

In addition, the image sensor and the imaging apparatus consistent with disclosed embodiments may generate a capture image without shutter lag even while performing an in-sensor zoom function.

In addition, the image sensor and the imaging apparatus consistent with disclosed embodiments may generate a high-quality capture image without shutter lag, even while performing an in-sensor zoom operation.

While example embodiments have been shown and described above, it will be apparent to those skilled in the art that modifications and variations could be made without departing from the scope of the present inventive concept as defined by the appended claims.

What is claimed is:

1. An imaging apparatus comprising:
an image sensor, wherein the image sensor comprises:
a pixel array comprising a plurality of pixels, the pixel array providing a pixel signal;
a readout circuit configured to output non-Bayer patterned first image data based on the pixel signal; and
an image signal processor configured to remosaic at least a portion of the first image data and output Bayer patterned second image data;
a display device or a storage device; and
an application processor, wherein the application processor is configured to:
control the image sensor;
generate Bayer patterned third image data based on the Bayer patterned second image data; and
based on the generated Bayer patterned third image data:
display a preview image on the display device; or
store a capture image in the storage device,
wherein the pixel array comprises a non-Bayer patterned color filter array.

2. The imaging apparatus of claim 1, wherein:
the color filter array comprises a plurality of color filter groups,
each of the plurality of color filter groups comprises a plurality of color filters disposed adjacent to each other and configured to allow lights of a same spectrum to pass therethrough, and
adjacent color filter groups of the plurality of color filter groups are configured to allow light of different spectra to pass therethrough.

3. The imaging apparatus of claim 2, wherein the application processor is further configured to:
generate the preview image by performing a first image processing on the third image data in response to a camera-on request and display the preview image on the display device; and
generate the capture image by performing a second image processing on the third image data in response to a capture request and store the capture image in the storage device.

4. The imaging apparatus of claim 3, wherein the image signal processor remosaics the portion of the first image data and outputs the Bayer patterned second image data in response to both the camera-on request and the capture request.

5. The imaging apparatus of claim 3, wherein the application processor is configured to remove one or more artifacts from the Bayer patterned second image data to generate the Bayer patterned third image data.

6. The imaging apparatus of claim 1, further comprising a memory device configured to store the third image data, wherein the application processor is further configured to store the third image data, the third data including a plurality of frames, in the memory device.

7. The imaging apparatus of claim 6, wherein the application processor is further configured to generate the capture image based on at least one piece of the third image data stored in the memory device prior to a predetermined time, from the plurality of frames of the third image data, in response to the capture request.

8. The imaging apparatus of claim 1, wherein the image signal processor comprises:
an image crop circuit configured to crop a portion of the first image data in response to a zoom command received from the application processor; and
a remosaic circuit configured to remosaic the cropped portion of the first image data and generate the second image data.

9. The imaging apparatus of claim 1, wherein the image signal processor comprises:
an image binning circuit configured to bin the first image data in response to a preview command received from the application processor; and
a remosaic circuit configured to remosaic the binned portion of the first image data and generate the second image data.

10. The imaging apparatus of claim 1, wherein the plurality of pixels comprise more than 100 million pixels.

11. An image sensor comprising:
a pixel array comprising a plurality of pixels, the pixel array providing a pixel signal;
a readout circuit configured to output non-Bayer patterned first image data based on the pixel signal; and
an image signal processor configured to:
receive a zoom command from an application processor;
receive a preview command from the application processor; and
remosaic at least a portion of the non-Bayer patterned first image data and output Bayer patterned second image data in response to both the zoom command and the preview command; and
wherein the pixel array comprises a non-Bayer patterned color filter array.

12. The image sensor of claim 11, wherein:
the color filter array comprises a plurality of color filter groups;
each of the plurality of color filter groups comprises a plurality of color filters disposed adjacent to each other and configured to allow lights of a same spectrum to pass therethrough; and
adjacent color filter groups of the plurality of color filter groups are configured to allow light of different spectra to pass therethrough.

13. An electronic device comprising:
an image sensor;
a display device or a storage device; and
an application processor, the application processor being configured to:
control the image sensor;
receive Bayer patterned first image data from the image sensor;
remove one or more artifacts from the Bayer patterned first image data to generate Bayer patterned second image data; and
display a preview image based on the Bayer patterned second image data on the display device or store a capture image based on the Bayer patterned second image data in the storage device.

14. The electronic device of claim 13, wherein a resolution of the Bayer patterned second image data is a same as a resolution of the Bayer patterned first image data.

15. The electronic device of claim 14, wherein the application processor is further configured to:
generate video frames based on the Bayer patterned second image data; and
store the video frames in the storage device.

16. The electronic device of claim 13, wherein the application processor is further configured to:
transmit a zoom command to the image sensor; and
receive the Bayer patterned first image data from the image sensor in response to the zoom command.

17. The electronic device of claim 13, further comprising a memory device, the application processor being further configured to:
store a plurality of frames of the Bayer patterned second image data in the memory device; and
generate the capture image based on at least one piece of the Bayer patterned second image data stored in the memory device prior to a predetermined time, from the plurality of frames of the Bayer patterned second image data, in response to a capture request.

18. The electronic device of claim 17, wherein the application processor is further configured to:
generate video frames in response to a video storage request, wherein at least a portion of the video frames are generated based on at least one piece of the Bayer patterned second image data stored in the memory device.

19. The electronic device of claim 18, wherein the electronic device generates a first frame of the video frames using at least one piece of the Bayer patterned second image data stored in the memory device.

20. The electronic device of claim 13, wherein the application processor performs different types of image signal processing on the Bayer patterned second image data to generate both the preview image and the capture image.
